(19) United States
(12) Patent Application Publication
(10) Pub. No.: US 2015/0373104 A1
(43) Pub. Date: Dec. 24, 2015

(54) WEB-BASED PUBLISHING OF ENTERPRISE INFORMATION

(71) Applicants: Dominic TONNA, (US); Alan FISHER, Sydney, New South Wales (AU); RED RAIN CORPORATION PTY LTD, Sydney, New South Wales (AU)

(72) Inventors: Stephen Butler, Sydney (AU); Dominic Tonna, Sydney (AU); Alan Fisher, Sydney (AU)

(21) Appl. No.: 14/766,974

(22) PCT Filed: Feb. 21, 2014
(86) PCT No.: PCT/AU2014/000159

§ 371 Date: Aug. 10, 2015

(30) Foreign Application Priority Data
Feb. 21, 2013 (AU) 2013900589

(51) Int. Cl. H04L 29/08; H04L 29/06; G06F 17/30

(52) U.S. Cl. CPC H04L 67/1095; G06F 17/30174; H04L 67/42; G06F 17/30289; G06F 17/30011

(57) ABSTRACT

A system and method is described for providing enterprise information to a mobile communications device. The system receives enterprise information from server based application software products at a publisher, and determines particular enterprise data from the enterprise information and integrates the particular enterprise data into a normalised data structure. The normalised data structure is stored on a local server in a Sync database and platform, wherein at least part of the normalised data structure may be accessed through an application user interface on mobile or web based communication devices.

### FIELD OF THE INVENTION

The present invention relates to web-based publishing of data and information. More particularity, the present invention provides a system and method for publishing an integrated, normalised data structure to the cloud to make particular enterprise data available to remote and mobile devices.

### DESCRIPTION OF THE RELATED ART

Professional service providers such as lawyers, accountants, engineers and consultants are continually relying on up-to-date information being provided in ‘real-time’. Mobile devices, such as smart phones, are common place in such professional service environments to give users instant access to email and other types of communication such as video teleconferencing.

Media tablet computers, such as Apple's iPad®, are becoming popular for professional service providers due to ease of use, functionality, mobility and processing ability. Instead of carrying bulky paper files to client sites, professionals may download relevant portions of information to the tablet device in a suitable format for reading and display (such as Portable Document Format (.PDF)).

Knowledge providers are supplying information and particular business functionality to tablet devices by way of applications (commonly referred to as ‘apps’) that may be purchased end downloaded directly to the device. However, there are only a limited number of professional service business apps. These apps provide only stand alone functionality, and are not integrated into the professional firm's office system and infrastructure.

The present invention advantageously provides an alternative to existing publishing technology. The invention according to certain embodiments may advantageously be used allow mobile access to enterprise data and information in an integrated manner.

### SUMMARY OF THE INVENTION

According to a first aspect of the invention, there is provided a system and method for providing enterprise information to a mobile communications device. The system receives enterprise information from server based application software products at a publisher, and determines particular enterprise data from the enterprise information and integrates the particular enterprise data into a normalised data structure.

The normalised data structure is stored on a local server in a Sync database and synchronised to a cloud-based storage platform, wherein at least part of the normalised data structure may be accessed through an application user interface on mobile or web based communication devices.

New data may be captured via user input to the communication devices and stored on the cloud-based storage platform to be added to the back-end storage devices, such as enterprise servers, through the server based application software products.

### BRIEF DESCRIPTION OF THE DRAWINGS

The invention will now be described in a non-limiting manner with respect to a preferred embodiment in which:

FIG. 1 is an overview of the technical architecture according to a preferred embodiment of the present invention.

FIG. 2 is an overview of the technical architecture according to a further preferred embodiment of the present invention.

FIG. 3 is an overview of the technical architecture according to another preferred embodiment of the present invention.

### DETAILED DESCRIPTION OF PREFERRED EMBODIMENTS

In the following discussion and in the claims, the terms “including” end “includes” are used, and are to be read, in an open-ended fashion, and should be interpreted to mean “including, but not limited to . . . ”.

Professional service providers, such as lawyers, generally provide advice to clients in relation to particular issues and perform work or tasks as discrete jobs, typically known as ‘matters’.

Information relating to matters will vary depending upon the nature of the work. For example, a family law matter will record particular enterprise data regarding the husband, wife, assets, and other similar information, while a property conveyance matter will have particular enterprise details of the property, purchaser/vendor, and council issues, as well as other relevant information.

In relation to legal issues, the practice is principally about documents such as contracts, forms, briefs and other correspondence. Increasingly, this correspondence is electronic and email based. Depending upon the type of law practiced, lawyers are part of a fairly mobile profession with a requirement to visit clients, brief barristers and attend court hearings. Having particular matter information readily available is therefore of utmost importance and is typically addressed by transporting paper files.

Further, as professional advice is an intangible service, firm accounting is based around time recordation or fee arrangements such as performance based or fixed fee.

Above this, professional services are a growing market both in terms of number of practitioners and the ratio of practitioners to the general population. There is also a trend of the practitioners becoming more ‘hands on’ with technology as the technology becomes more applicable to the job role. Further, an increasing environmental awareness has seen many companies utilising (or even insisting on) “green” policies by using electronic media to limit the use of paper, for example. Integrating this complex web of enterprise information is quite challenging and requires a number of support systems.

The following example of support systems relates to the legal profession environment. It will be appreciated by the skilled person that similar systems are applicable to other professional services.

To support business processes such as those described above, a law firm wilt typically use a range of systems that are generally server based application software products to generate and support enterprise information. Enterprise information is generally stored on back-end servers or storage devices. The server based application software products can be broadly categorized as per below. It will be appreciated that this is not an exhaustive list, and other products may be added or substituted to suit the application environment or practice.

Practice Management Systems (billing end accounts): software that manages the recording of time, the billing process, the bust account as well as general accounting functions, such as accounts receivable, accounts payable, banking, and general ledger. Practical examples of this type of software include Open Practice, Aderant®, LEAP®, and Inprotech®.

Matter Management: software that manages matter specific information. These systems typically allow the extension of the database for the capture of extra information that is specific to the type of matter, usually allowing user definition of fields. Depending upon the level of sophistication of the product used, the tool may also allow for automated document assembly, process automation and the calculation of dates, reminders and the management of task lists. Practical examples of this type of software include Caseflow®, and MatterSphere®.

Document Management: software that manages the storage, organisation and retrieval of electronic documents and emails. This generally includes scanned incoming paper based correspondence. Practical examples of this type of software include Wordox®, and iManage®.

Client Relationship Module (CRM): software to manage information related to clients for marketing and relationship purposes. Practical examples of this type of software include Interaction®, and CRM4Legal®.

Knowledge Management: software for the management of corporate knowledge internally. At a basic level, this is precedent documents and access to structured information via the firm's intranet. At a more sophisticated level, it includes search and data mining across all systems. A practical example of this type of software includes Reccomind®.

Workflow: software for the management and integration of internal processes and systems. Take up of this technology has generally been slow. A practical example of this type of software includes Flosuite®.

Depending upon the size of the firm, the nature of the solution and the sophistication of the requirement, a firm may use one or many products to address systems requirements.

It will be appreciated that the terms “enterprise information” or “enterprise data” may relate to any document or data captured or generated in any of the above mentioned server based application software products. Enterprise data is to be given a broad meaning and relates to a subset of enterprise information.

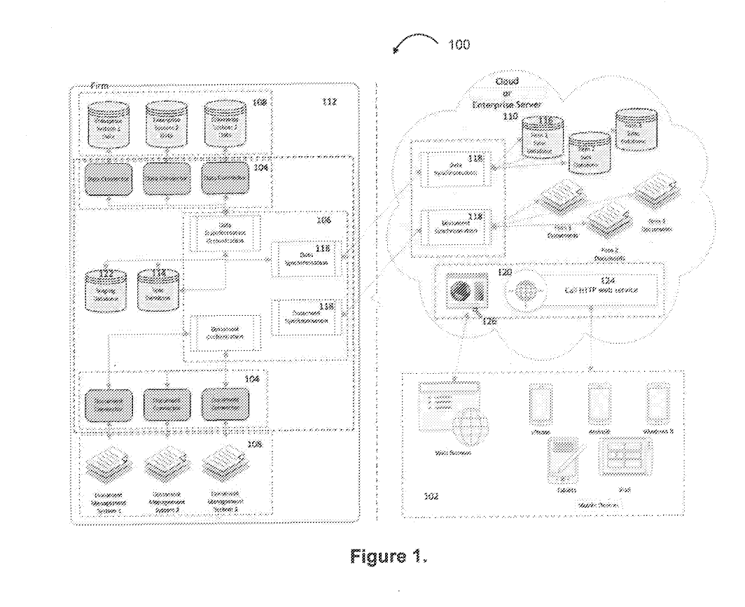

In accordance with a preferred embodiment of the present invention, FIG. 1 shows a web publishing system 100 that allows collaborative enterprise information to be consolidated into a single interface for access by mobile or web enabled devices 102.

The example embodiment of FIG. 1 shows a professional service firm's IT infrastructure 112 utilising any number of application and data servers to provide business systems and support. This local infrastructure may be located physically within the firm's premises or at an outside data centre.

The system 100 preferably comprises at least one connector 104 that allows the different server based application software products and corresponding enterprise data servers 108 to monitor for changes in enterprise information and documents, and pass this information to the publisher 106.

The publisher 106 integrates particular enterprise data from the enterprise information into a uniform and normalised data structure and then synchronises this to the cloud 110. It will be appreciated that the cloud may be a public or private cloud, or other suitable mass-storage system with connectivity to the relevant local infrastructure 112.

In a preferred embodiment, management of the synchronisation, storage, network scalability and delivery of information to the cloud is facilitated using Microsoft® Azure®. However, it will be appreciated that other systems could also suitably handle this functionality, or the relevant web access services (described below) may be housed within the enterprise systems.

The normalised data structure provided by the publisher 106 allows an integrated, cloud-based database of information that collaborates particular enterprise data from the enterprise information of many systems into one common structure.

The publishing process will now be described utilising a .Net Windows Service, which runs unattended in the local back-end IT environment of a professional service firm 112. It will be appreciated that the following description outlines an exemplary model, and alternative systems may be utilised to provide the advantages of the present invention.

The publisher 106 is set up with access to the server based application software products utilised by the professional firm. On a preferably configurable scheduled base, the service requests any changes in data from the source servers 108 via the data connectors 104 which have occurred since the last synchronisation process.

The identified data changes are then transferred to a staging database 122 and subsequently transformed from the staging database 122 to a normalised data structure in a local copy of a Sync database 114. Relevant data relationships are created between the normalised data structures in the Sync database. The system then merges associated metadata that describes the data, data relationships and allowed user access which will be used by the mobile devices 102 to access the information, into the local copy of the Sync database 114. A local copy of the Sync database 114 is synchronised into a cloud based copy 116, using synchronisation services 118. Preferably, the metadata ensures that the user licensing and access security rules are applied when data is accessed by users from the cloud 110 depending on the role they have been given.

The detected changes of data are merged from the source system with the local Sync database 114 and then synchronised to the Sync database 116 in the cloud 110. Conversely, detected changes to the data in the cloud are stored in the cloud based Sync database 116 via the cloud based web application 120, synchronised back to the local Sync database 114 via the synchronisation services 118, and then merged with the normalised data from the source systems data. The changes are then incorporated into the enterprise data bases 108 using the data connectors 104.

These changes detected in the source system are managed by keeping checkpoints in a staging database, as metadata, for each type of data that is requested via the data connecter 104. For example, the data connector for the LEAP application calls the LEAP API, and would be target system specific using other data connectors. For LEAP, for example, the checkpoints are identified via the USN (Unique Sequence Number) which is specific to each type of data in this system, such as clients and matters.

As briefly mentioned above, when changes are identified or detected in the source system, retrieval of that information is initiated and the information is stored in a staging database 122. The staging database 122 provides the ability to store the retrieved data into flat date structures, and update the existing data appropriately once the change has been identified as occurring at the source. Preferably, to increase efficiency, staging only ever stores the latest image of a record which would reflect the actual state of the data at the source. Preferably, the update history is removed to simplify processing.

The staging database 122 also defines how each of the data elements relate to each other via associated knowledge based rules.

After the data is updated into flat data structures in the staging database 122, the publisher 106 uses the knowledge based rules to perform the necessary data transformations and creation of data relationships to store the data in a generic, normalised database—the Sync database 114—in preparation for synchronising with data in the cloud 110. The change information received via the connector 104 also identifies which enterprise data have been added or changed at the source.

The data connectors 104 control all aspects of maintaining the data in the staging database. The publisher 106 communicates with the connectors 104 rather than directly with the server based application software products and corresponding servers 108, allowing easy plug-in of additional services to the publisher 106 and overall system. It will be appreciated that the components already present in the system will not need to change with any addition as they are independent of any proprietary data structures.

As mentioned, the publisher 106 orchestrates communication with the connectors 104 and then, applying the knowledge based rules to undertake data transformation, determines what data to publish to the cloud 110. The data in the local Sync database 114 is preferably intelligent and self-defining, in that it need not be aware of any of the structures within the source systems. It also includes the metadata which defines the data ownership of information to allow information to be filtered to the appropriate end user, according to the rules setup by the professional service firm. The metadata may include the type of user (for example, lawyer or external user) and the client/matter ownership data that is defined by responsibility to the client/matter as defined in the source system, or the client's association to the particular record in the source system which then relates to the relevant matters.

The data transformation tasks are stored within the staging database and data relationships are created to transform the data into the required generic (source system agnostic) structures required by the processing software 120 in the cloud 110. The transformed data is preferably stored in a local copy of the Sync database 114, stored on an enterprise server within the firm's infrastructure 112, and then synchronised to the cloud 110.

The publisher 106 then facilitates communication with the connectors 104 and the local Sync database 114, applying knowledge based rules to determine which documents to publish and republish. The publisher may then retrieve documents as file streams from the source systems 108 via the connectors 104. A copy of the extracted documents is then stored on the file server in their originating format for later synchronisation to the cloud 110.

Preferably, the publisher 106 utilises Microsoft® Sync Framework to synchronise the data in the local Sync database 114 to the cloud-based Azure® Sync database 118. This is a two-way synchronisation process in that the local Sync database will also be updated with data changed in the cloud 110.

As mentioned above, the role/type of the end user is defined via a role definition provided by the professional services firm. These roles may be defined and stored in the database in the cloud and define which data elements should be displayed for each user role. The firm can define any number of user roles and the data to be accessible for that role.

Data access rules may also be defined to determine which matters can be accessed by each individual end user. These rules are defined at the role level, but are applied at the end user level. A combination of the metadata rules stored in the staging database, as well as the rules defined in the cloud, is used to filter information from the originating staging database.

Data updates from the end user on a mobile device 102 back to the source system 108 are achieved in a similar fashion to the above steps, applied in reverse. That is, the changes or additions made to the published data are captured and the relevant information entered is stored on the Azure® Sync database 116. The Microsoft® Sync Framework will identify the data changes and synchronise the data from the cloud 110 back into the local instance of the Sync database 114.

The publisher 106 will then identify the data updates in the Sync database and initiate a call to the connectors to update the data into the source systems 108.

Data updates may include new file notes which can be attached to matters, a new transaction or event (such as time recording), a new document which can be scanned or loaded via the mobile device 102, or a matter management task which can be initiated at the mobile device 102 and actioned by the enterprise servers.

It will be appreciated that conflict resolution techniques must apply where multiple users are accessing the same document or data. For example, a secondary user accessing a document after a primary user has initiated access will not be given editing rights until the primary user has exited the document.

Preferably, generic rules are configurable by the user to define what data is automatically published. The rules are applied every time the process runs which eliminates the necessity for user interaction to select actual matters and documents for availability on the end user device.

The published information is preferably made available to end users via their preferred mobile access method or web enabled device 102.

The end user initiates access to the published information through a web based application and web services 120 hosted in the cloud. Date is accessed via a Web Browser, via suitable Apple® devices or other PDA and smart phone devices 102.

The web browser applications on the user devices 102 communicate with the associated web application 120 in the cloud 110, via a suitable high availability and scalable web services 124 utilising IIS 126, to access data from the SQL Azure® database 116 and document objects, as required. The web services 124 utilise the metadata and ownership data within the SQL Azure® database 116 to determine what to display (to the user) and how it should be displayed by interpreting the self-defining aspects of the information. The web services orchestrate and control secure access to the data access layer of the solution.

Smart phone and tablet devices bypass the user interface layer and communicate directly with the web services 124 to retrieve the required information. The app downloaded on the device then displays the information, dynamically identifying the form factor to be used. The actual device in this instance acts as the user interface layer (GUI).

It will be appreciated that the same synchronised data can be accessed via Desktop applications, HTML Browsers, iPhone®, iPad®, Android® and other smart phones and devices, without the need to change the synchronisation database, the synchronisation framework or the user-side web application, regardless of the source systems or the user device chosen.

It will be further appreciated that the publisher of the present invention is continually identifying changes in information on the source systems and publishing these changes to the cloud, allowing users to have the latest information to hand. Preferably, the process steps can be configured to be scheduled at any custom interval, for example from every 2 minutes to once a day.

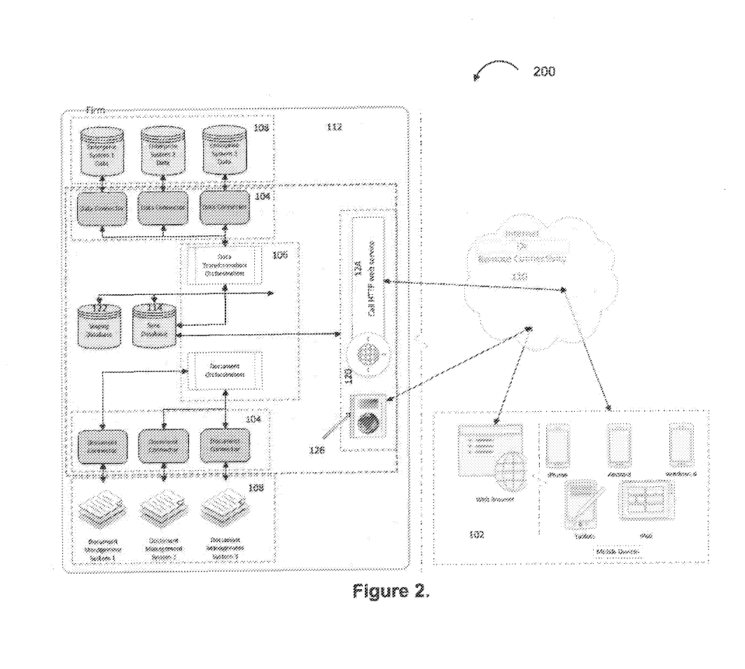

FIG. 2 depicts an alternative embodiment of the present invention without the use of cloud based storage or processing. In this embodiment, the data access components are housed within the firm's infrastructure 112 and communicate with the local Sync database 122 directly. This embodiment may be preferred where security issues are of concern with cloud based storage or processing. Additionally, this embodiment may be preferred when the present invention is incorporated in a local network to be used as the professional service firm's ‘home page’ for employee (and even client) access utilising a web browser 102 on a computer terminal or laptop. It will also be appreciated that the embodiments shown in FIGS. 1 and 2 could be used concurrently in accordance with business requirements and desires.

In this embodiment shown in FIG. 2, the system 200 components use common reference numerals as in FIG. 1, and the above described processes in relation to FIG. 1 can similarly be incorporated into the embodiment of FIG. 2. As can be seen, the internet 110 in FIG. 2 facilitates remote connection from mobile devices 102 to the web access services 124.

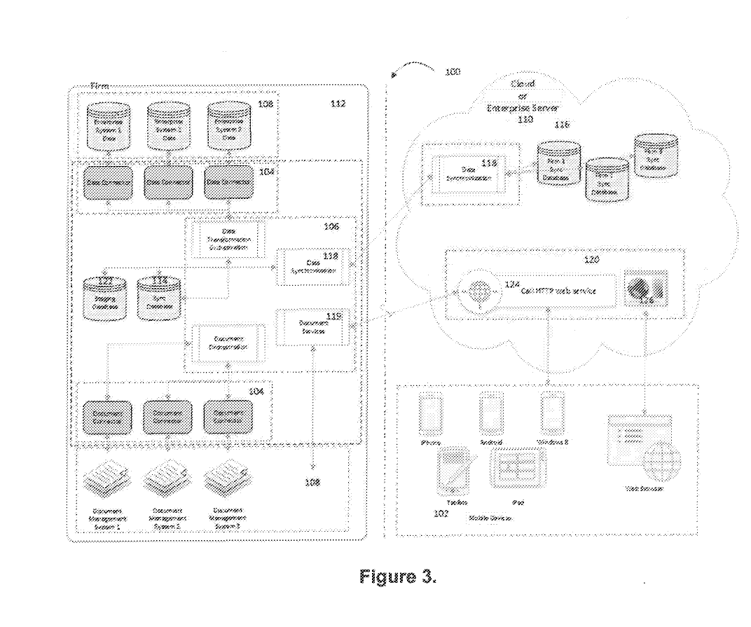

Following on from above, FIG. 3 shows a further alternative embodiment of the present invention where documents are not synchronised to the cloud. Again, similar components use common reference numerals as in FIG. 1, and the above described processes in relation to FIG. 1 can similarly be incorporated into the embodiment of FIG. 3 where appropriate. The web service 124 in the cloud provides document services to the browser and mobile devices 102 by communicating directly with a document service 119 at the local environment 112. This document service 119 goes directly to the document source 108 and returns the appropriate document. This alternative approach eliminates the need to synchronise larger volumes of documents between Azure and the Firm which is impractical for large sites.

The present invention allows automatic publication of relevant enterprise information to the cloud. Documents for publication are simply treated as part of the data with the same local publishing rules applied. This overcomes the inherent shortcomings of prior art systems which require the mobile user device to be connected to a local connected PC to allow the user to upload documents before leaving the office. The latest version of documents will automatically be available over the web without any prior user interaction or setup. Further on this point, it will be appreciated that the present invention will allow offline access to data and documents, allowing a user to decide which matters, contacts and associated documents will be stored on the device from the cloud while travelling to avoid connectivity costs.

It will be further appreciated that the present invention will allow users to remotely record time and store meeting notes or voice memos directly to particular matters using the publishing steps outlined above, without the need to load numerous applications onto the mobile device to perform these separate tasks.

It is to be understood that the above embodiments have been provided only by way of exemplification of this invention, and that further modifications and improvements thereto, as would be apparent to persons skilled in the relevant art, are deemed to fall within the broad scope and ambit of the current invention described and claimed herein.

The claims defining the invention are as follows:

1. A method for providing enterprise information to a mobile communications device, including:
receiving enterprise information from server based application software products at a publisher;
selecting particular enterprise data from the enterprise information at the publisher;
integrating the particular enterprise data into a normalised data structure;
storing the normalised data structure on a cloud-based storage platform; and
accessing at least part of the normalised data structure on a mobile communications device from the cloud-based storage platform.

2. The method of claim 1, wherein selecting particular enterprise data from the enterprise information at the publisher is determined by rules incorporated as metadata in the enterprise data and stored on a staging database.

3. The method of claim 1, wherein the publisher is housed in local infrastructure.

4. The method of claim 3, wherein the normalised data structure is stored on a Sync database housed in the local infrastructure.

5. The method of claim 4, wherein the Sync database housed in the local infrastructure synchronises the stored normalised data structure to the cloud-based storage platform through the publisher.

6. The method of claim 5, wherein the cloud-based storage platform includes a further Sync database.

7. A system for providing enterprise information to a mobile communications device, including:
a publisher for:
receiving enterprise information from server based application software products;
determining particular enterprise data from the enterprise information; and
integrating the particular enterprise data into a normalised data structure;
a cloud-based storage platform for storing the normalised data structure; and
an application interface for providing access to at least part of the normalised data structure on a mobile communications device from the cloud-based storage platform.

8. The system of claim 7, further including a staging database for sturoing rules incorporating metadata used to determine the particular enterprise data from the enterprise information.

9. The system of claim 7, wherein the publisher is housed in local infrastructure.

10. The system of claim 9, further including a Synce database housed in the local infrastructure for storing the normalised data structure.

11. The system of claim 10, wherein the Sync database housed in the local infrastructure synchronises the stored normalised data structure to the cloud-based storage platform through the publisher.

12. The system of claim 11, wherein the cloud-based storage platform includes a further Sync database.
